(19) United States
(12) Patent Application Publication
(10) Pub. No.: US 2026/0290032 A1
(43) Pub. Date: Sep. 24, 2026

(54) SYSTEM FOR DETECTING TARGET OBJECT BASED ON ARTIFICIAL INTELLIGENCE AND AUTONOMOUS DRIVING SENSOR AND METHOD IMPLEMENTING THE SAME

(71) Applicants: Hyundai Motor Company, Seoul (KR); Kia Corporation, Seoul (KR)

(72) Inventor: Jin Ho PARK, Hwaseong-Si (KR)

(21) Appl. No.: 19/380,366

(22) Filed: Nov. 5, 2025

(30) Foreign Application Priority Data
Mar. 21, 2025 (KR) 10-2025-0036787

(51) Int. Cl. G06V 20/58; B60W 50/00; B60W 60/00; G05B 13/02; G06V 10/25; G06V 10/26; G06V 10/46; G06V 10/762; G06V 10/764; G06V 10/77

(52) U.S. Cl. CPC G06V 20/58; B60W 50/00; B60W 60/001; G05B 13/0265; G06V 10/25; G06V 10/267; G06V 10/46; G06V 10/762; G06V 10/764; G06V 10/77; B60W 2050/0028; B60W 2554/20; B60W 2554/40; B60W 2556/40; B60W 2556/45

(57) ABSTRACT

A system and a method for recognizing an object is disclosed. An AI module of the system performs a first step of generating a cluster including motion information by performing moving object segmentation (MOS) and a clustering operation from the pieces of point data, a second step of generating a bounding box, which includes the motion information, and includes classification information about a dynamic object, a static object, or another object, through post-processing based on the cluster including the motion information, and a third step of extracting a feature for determining whether the cluster including the motion information corresponds to a target object, based on the bounding box and generating a 3D pseudo GT bounding box by using an unlabeled point cloud frame through a classifier based on contrastive learning.

### CROSS-REFERENCE TO RELATED APPLICATION

This application claims the benefit of priority to Korean Patent Application No. 10-2025-0036787, filed in the Korean Intellectual Property Office on Mar. 21, 2025, the entire contents of which are incorporated herein by reference.

### TECHNICAL FIELD

The present disclosure relates to a system and a method for detecting a target object by an artificial intelligence (AI) and an autonomous driving sensor, and more particularly, relates to a system for extracting a target object by an AI and an autonomous driving sensor that are capable of generating a pseudo GT bounding box for an unlabeled cluster by using moving object segmentation (MOS) and contrastive learning algorithm, and a method thereof.

### BACKGROUND

The matters described in this Background section are only for enhancement of understanding of the background of the disclosure, and should not be taken as acknowledgment that they correspond to prior art already known to those skilled in the art.

A variety of sensors and artificial intelligence (AI) technologies are increasingly being used to support the autonomous driving function of a vehicle. For example, research is ongoing on an object in front of a moving vehicle, a distance between the object and the vehicle, and an algorithm in which the vehicle responds to specific situations to ensure safety.

Accordingly, a vehicle sensor technology is becoming advanced, and high-performance sensors such as Light Detection and Ranging (LiDAR) that recognizes surrounding environments by using laser beams, Radio Detection and Ranging (RADAR) that uses radio waves, an ultrasonic sensor, a fisheye camera capable of capturing 360-degree images, a multifocal lens, and a global positioning system (GPS) are being installed in vehicles.

As such, a super sensor vehicle may be implemented by aggregating measurement results obtained from a plurality of sensors. In self-driving (autonomous driving), the concept of a super sensor refers to a technology that accurately recognizes surrounding environments for comfort or safety by combining measured values from a variety of sensors rather than relying on individual sensors. Here, with the addition of information and communications technology (ICT) and cloud technology, sensors required for autonomous driving, and AI algorithms related thereto are becoming more sophisticated than ever, to increase the reliability of the determination of vehicle sensors by remotely accumulating data from numerous fleets of vehicles without targeting only a single vehicle and training an AI server and a database.

However, efforts to further enhance object recognition performance are ongoing.

### SUMMARY

The present disclosure was made to solve the above-mentioned problems.

An example of the present disclosure provides a system and a method for detecting a target object by an AI and an autonomous driving sensor, and more particularly, provides a system for extracting a target object by an AI and an autonomous driving sensor that are capable of generating a pseudo GT bounding box for an unlabeled cluster by using MOS and contrastive learning algorithm, and a method thereof.

The technical problems to be solved by the present disclosure are not limited to the aforementioned problems, and any other technical problems not mentioned herein will be clearly understood from the following description by those skilled in the art to which the present disclosure pertains.

To solve all or at least part of the above-described technical problems, the present disclosure may be implemented in various examples as follows.

According to the present disclosure, an apparatus of a vehicle may comprise a sensor configured to obtain pieces of point data associated with a surrounding environment of the vehicle, a memory configured to store the pieces of point data, and a processor circuit. The processor circuit may be configured to recognize, based on processing of the pieces of point data using an artificial intelligence model, at least one object in the surrounding environment of the vehicle. Based on performing moving object segmentation (MOS) and a clustering operation on the pieces of point data, the processor circuit may generate a cluster, wherein the cluster comprises motion information associated with the at least one object. Based on post-processing the cluster, the processor circuit may generate a bounding box, wherein the bounding box comprises the motion information. The processor circuit may obtain, based on the bounding box, a feature for determining whether the cluster corresponds to a target object of the at least one object. The processor circuit may apply contrastive learning to the obtained feature for generating classification information, wherein the classification information indicates whether the cluster corresponds to a moving object or a static object. Based on the bounding box, the classification information, and a determination that the cluster corresponds to the target object, the processor circuit may generate a three dimensional (3D) pseudo ground truth (GT) bounding box by using an unlabeled point cloud frame, output a signal indicating the 3D pseudo GT, and control, based on the signal, autonomous driving of the vehicle.

The processor circuit may be configured to perform a ground estimation process and a process of removing at least one point from the pieces of point data, wherein the at least one point is irrelevant to the target object.

The processor circuit may be configured to perform the ground estimation process based on a pre-trained deep learning-based model applied to the pieces of point data, or a rule-based model that estimates ground points based on normal vectors associated with the pieces of point data.

The processor circuit may be configured to perform the MOS based on an iterative closest point (ICP) between consecutive frames of the pieces of point data, or occupied or unoccupied regions of a map generated from the pieces of point data.

The processor circuit may be configured to perform the MOS by using a self-supervised learning model configured to detect motion based on nearest neighbor points in the pieces of point data.

The processor circuit may be configured to perform an unsupervised learning-based clustering process on the pieces of point data to generate the bounding box.

The processor circuit may be configured to perform the unsupervised learning-based clustering process in three dimensions by grouping points in the pieces of point data that satisfy a point density condition and identifying points that do not satisfy this point density condition as noise.

The processor circuit may be configured to perform a binary classification process to determine whether the cluster corresponds to the target object, and generate the bounding box based on a determination of whether the cluster corresponds to the target object.

The binary classification process may be configured to classify the cluster as the target object, wherein the target object corresponds to the moving object or the static object, or as a non-target object, based on the unsupervised learning-based clustering process and the MOS.

The processor circuit may be configured to obtain the feature for determining whether the cluster corresponds to the target object using a feature extraction process, and the feature extraction process may be configured to generate features invariant to rotations of the cluster.

According to the present disclosure, a method may be performed by an apparatus of a vehicle. The method may comprise obtaining, from a sensor, pieces of point data associated with a surrounding environment of the vehicle, and based on performing moving object segmentation (MOS) and a clustering operation on the pieces of point data, generating a cluster, wherein the cluster comprises motion information associated with a target object in the surrounding environment of the vehicle. Based on post-processing the cluster, the method may include generating a bounding box, wherein the bounding box comprises the motion information. Based on the bounding box, a feature may be obtained for determining whether the cluster corresponds to the target object. Contrastive learning may be applied to the obtained feature for generating classification information, wherein the classification information indicates whether the cluster corresponds to a moving object or a static object. Based on the bounding box, the classification information, and a determination that the cluster corresponds to the target object, the method may comprise generating a three dimensional (3D) pseudo ground truth (GT) bounding box by using an unlabeled point cloud frame, outputting a signal indicating the 3D pseudo GT, and controlling, based on the signal, autonomous driving of the vehicle.

The generating of the cluster may comprise performing a ground estimation process and removing at least one point from the pieces of point data, wherein the at least one point is irrelevant to the target object.

The performing of the ground estimation process may be based on a pre-trained deep learning-based model applied to the pieces of data, or a rule-based model that estimates ground points based on normal vectors associated with the pieces of point data.

The performing of the MOS may be based on aligning consecutive frames of the pieces of point data, or detecting changes in occupied or unoccupied regions of a map generated from the pieces of point data.

According to the present disclosure, a vehicle may comprise a sensor configured to obtain point cloud data associated with at least one object in a surrounding environment of the vehicle, a driving control circuit configured to control autonomous driving of the vehicle, and a processor circuit. The processor circuit may be configured to cause the vehicle to segment the point cloud data to distinguish points corresponding to the at least one object from points corresponding to a background, generate, based on the points corresponding to the at least one object, a cluster corresponding to the at least one object, and generate a bounding box corresponding to the cluster. The processor circuit may be configured to apply contrastive learning to classify features extracted from the cluster, determine, based on the classified features, that the cluster corresponds to a target object among the at least one object, and based on the determination and the bounding box, generate a pseudo ground truth bounding box corresponding to the target object. The processor circuit may be further configured to output a signal indicating the pseudo ground truth bounding box, and control, via the driving control circuit and the signal, autonomous driving of the vehicle.

The processor circuit may be configured to cause the vehicle to remove points corresponding to a ground from the point cloud data prior to generating the cluster.

The processor circuit may be configured to cause the vehicle to identify points corresponding to the at least one object by comparing consecutive frames of the point cloud data to detect motion of the at least one object.

The processor circuit may be configured to cause the vehicle to track the pseudo ground truth bounding box across a plurality of frames of the point cloud data to maintain continuity of the target object.

The target object may be in an unlabeled point cloud frame of the point cloud data, and the processor circuit may be configured to cause the vehicle to use the pseudo ground truth bounding box for training of an object recognition model associated with autonomous driving of the vehicle.

The processor circuit may be configured to cause the vehicle to apply contrastive learning such that features extracted from clusters corresponding to a same class are adjusted to be closer together in a feature space and that features extracted from clusters corresponding to different classes are adjusted to be farther apart in the feature space.

### BRIEF DESCRIPTION OF THE DRAWINGS

The above and other objects, features and advantages of the present disclosure will be more apparent from the following detailed description taken in conjunction with the accompanying drawings:

FIG. 1 shows an exemplary overall system for automatically recognizing an object and controlling a vehicle for the purpose of autonomous driving;

FIG. 2 shows an example of an algorithm for extracting, inferring, and classifying features of a target object through MOS and contrastive learning;

FIG. 3 shows an example of recognizing the ground;

FIG. 4 shows an example of a MOS result based on an iterative closest point (ICP) or mapping; and

FIG. 5 shows an example of a computing system for autonomous vehicle control and object recognition operations.

### DETAILED DESCRIPTION

Hereinafter, some examples of the present disclosure will be described in detail with reference to the accompanying drawings. In adding reference numerals to components of each drawing, it should be noted that the same components include the same reference numerals, although they are indicated on another drawing. Furthermore, in describing the examples of the present disclosure, detailed descriptions associated with well-known functions or configurations will be omitted when they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms used herein, including technical or scientific terms, include the same meaning as commonly understood by one of ordinary skill in the technical field to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein. For example, in the present disclosure, term “object” includes substantially the same meaning as “gaegche (in Korean)”, and expressions “object” and “gaegche” are used interchangeably in the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of controlling a door of the vehicle) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of pseudo ground truth generation via motion-aware clustering and contrastive learning) described herein. In particular, when pseudo ground truth (GT) bounding boxes generated from clustered point cloud data and refined through contrastive learning indicate the presence of nearby obstacles or sudden changes in the motion state of surrounding objects, auxiliary devices may be activated to provide additional braking or vehicle stabilization (e.g., engaging an engine brake when pseudo GT detects a slowing vehicle ahead, activating regenerative braking when clustering identifies a static obstacle in the lane, or applying a hydraulic retarder when classification results show high-speed approaching vehicles, etc.). Conversely, when pseudo GT indicates a stable driving environment with consistent object recognition, auxiliary braking force may be reduced or minimized to improve driving comfort and energy efficiency.

One or more communication devices (e.g., a modem, a network adapter, a radio transceiver, an antenna, etc., capable of communicating via one or more wired or wireless communication protocols, such as Ethernet, Wi-Fi, near-field communication (NFC), Bluetooth, Long-Term Evolution (LTE), 5G New Radio (NR), or vehicle-to-everything (V2X), etc.) may also be controlled, for example, based on one or more features (e.g., feature of pseudo ground truth generation via motion-aware clustering and contrastive learning) described herein. In particular, when pseudo ground truth (GT) bounding boxes generated from clustered point cloud data and refined through contrastive learning indicate degraded detection reliability or classification uncertainty, communication devices may be adaptively configured to transmit additional data (e.g., sharing raw LiDAR frames, transmitting clustering outputs, or broadcasting confidence levels of pseudo GT bounding boxes to nearby vehicles or infrastructure, etc.). Likewise, when pseudo GT bounding boxes are determined to be stable and reliable, communication bandwidth may be optimized by reducing transmission frequency or limiting shared data to high-confidence object information. This adaptive communication control enables efficient use of V2X and network resources while enhancing collaborative perception and safety in autonomous driving environments.

Minimum risk maneuver (MRM) operation(s) may also be controlled, for example, based on one or more features (e.g., feature of pseudo ground truth generation via motion-aware clustering and contrastive learning) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. In this disclosure, an MRM may be activated when pseudo ground truth (GT) bounding boxes generated by motion-aware clustering and refined through contrastive learning indicate that object detection reliability has degraded or classification errors persist. For example, when pseudo GT bounding boxes become inconsistent across frames, when clusters cannot be reliably matched to target objects, or when contrastive learning outputs indicate low discrimination confidence, the MRM may be triggered to maintain safety. The minimal risk maneuver may include operations such as controlled deceleration, lane-keeping toward the shoulder, or a safe stop (e.g., gradually slowing the vehicle, steering toward a road shoulder, or issuing emergency warnings, etc.). During the minimal risk maneuver, one or more processors of the vehicle may control driving operations for a set period of time until the vehicle reaches a safe state or a driver resumes control.

Biased driving operation(s) may also be controlled, for example, based on one or more features (e.g., feature of pseudo ground truth generation via motion-aware clustering and contrastive learning) described herein. A driving control apparatus may perform biased driving control by using pseudo ground truth (GT) bounding boxes generated from clustered point cloud data and refined through contrastive learning. To perform a biased driving operation, the driving control apparatus may adjust the vehicle's lateral position within a lane according to the reliability and classification consistency of the pseudo GT bounding boxes. For example, the driving control apparatus may cause the vehicle to remain within the lane but intentionally deviate from the lane center when pseudo GT indicates nearby moving objects or static obstacles (e.g., adjacent vehicles, cyclists, or roadside barriers, etc.). The driving control apparatus may identify or determine a biased target lateral distance for biased driving based on the confidence level of pseudo GT classification and clustering results. For example, the biased target lateral distance may comprise an intentionally adjusted lateral offset that a vehicle aims to maintain from a reference point, such as the lane center, in order to increase safety margins from detected objects. This adjustment may improve the vehicle's stability, safety, and performance under varying conditions. For example, during a lane change, the driving control system may bias the lateral distance to maintain a safer gap from adjacent vehicles or roadside obstacles, considering factors such as the pseudo GT reliability, vehicle speed, road conditions, and the presence of static or dynamic objects.

One or more sensors (e.g., IMU sensors, camera, LiDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of pseudo ground truth generation via motion-aware clustering and contrastive learning) described herein. An operation control for autonomous driving of the vehicle may include dynamically adjusting the sensing functions of the sensors depending on the reliability of pseudo GT generation (e.g., increasing LiDAR sampling rate when bounding box consistency decreases, narrowing camera field of view for improved feature discrimination, or activating additional RADAR units when clustering instability is detected, etc.). The control may further include adaptive coordination of the sensors to enhance object recognition and environmental awareness (e.g., fusing LiDAR and camera data when motion-aware clustering is uncertain, triggering recalibration of IMU-based motion estimates, or reconfiguring blind spot sensors when pseudo GT errors persist, etc.).

An autonomous driving activation/deactivation operation may be controlled based on one or more features (e.g., feature of pseudo ground truth generation via motion-aware clustering and contrastive learning) described herein. In particular, a diagnostic control apparatus may determine a pseudo ground truth (GT) bounding box for an object by segmenting moving points from background points, generating clusters, and applying contrastive learning to improve feature discrimination. When the pseudo GT status is reliable (e.g., object bounding boxes consistently generated across frames and validated by feature similarity metrics), autonomous driving may be enabled. When the pseudo GT status is uncertain (e.g., clusters intermittently mismatched, feature discrimination degraded, or bounding boxes inconsistent across frames), autonomous driving may be restricted (e.g., speed/acceleration limits, route constraints, or reduced feature set), and a driver takeover request may be prepared. When the pseudo GT status is invalid or critical (e.g., failure to generate bounding boxes, corrupted feature vectors, or persistent classification errors), autonomous driving may be deactivated and a minimal risk maneuver initiated (e.g., controlled deceleration, lane-keeping to shoulder, or safe stop), while issuing a warning that includes cluster-level and classification-level diagnostic information.

According to the present disclosure, an apparatus and method are provided for enhancing object recognition in autonomous driving by combining sensor data processing with artificial intelligence. The apparatus may obtain point cloud data from a sensor and apply moving object segmentation (MOS) to distinguish between dynamic elements, such as pedestrians or vehicles, and static elements, such as buildings or road surfaces. Clusters may then be generated from the segmented data, and bounding boxes may be assigned to represent respective clusters. To address the limitations of relying solely on manually created ground truth (GT) data, the apparatus may further apply contrastive learning techniques to extract and classify features of each cluster, thereby enabling the generation of pseudo GT bounding boxes using unlabeled point cloud frames. Through this approach, the apparatus may reduce dependence on extensive human labeling while improving the accuracy and efficiency of object detection and tracking in three-dimensional environments, thereby supporting more reliable autonomous vehicle control.

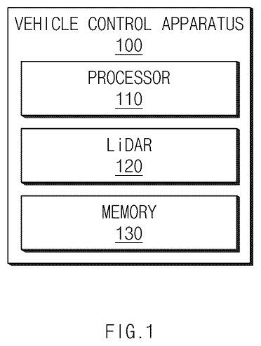

FIG. 1 shows an exemplary overall system for automatically recognizing an object and controlling a vehicle for the purpose of autonomous driving, according to an example of the present disclosure.

Referring to FIG. 1, a vehicle control apparatus 100 according to an example of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be coupled with control units of the vehicle by means of a separate connection means. For example, the vehicle control apparatus 100 may further include components not shown in FIG. 1.

The vehicle control apparatus 100 according to an example may include a processor 110, a LiDAR 120, and a memory 130. The processor 110, the LiDAR 120, or the memory 130 may be electronically and/or operably coupled with each other by an electronical component including a communication bus.

Hereinafter, the fact that pieces of hardware are coupled operably may include the fact that a direct and/or indirect connection between pieces of hardware is established by wired and/or wirelessly such that second hardware is controlled by first hardware among the pieces of hardware.

Although different blocks are shown, an example is not limited thereto. For example, some of the pieces of hardware in FIG. 1 may be included in a single integrated circuit including a system on chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an example may include hardware for processing data based on one or more instructions. For example, the hardware for processing data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may include the architecture of a single-core processor, or may include the architecture of a multi-core processor including a dual core, a quad core, a hexa core, or an octa core (e.g., depending on the computational complexity of perception models, route planning, or control logic, etc.).

According to an example, the processor 110 may include at least one of a graphic processing unit (GPU), or a neural processing unit (NPU), or any combination thereof. For example, the GPU may be referred to as a “visual processing unit (VPU)”. For example, the NPU may be referred to as a “neural network processing unit”.

The vehicle control apparatus 100 according to an example may include a depth sensor for detecting an external object. For example, the depth sensor for detecting an external object may include at least one of a time of flight (ToF) sensor, the LiDAR 120, a structured light sensor, an ultrasonic sensor, an infrared sensor, radio detection and ranging (RADAR), or an optical distance sensor, or any combination thereof e.g., combining LiDAR and RADAR to improve robustness in low-visibility conditions, etc.). Hereinafter, for convenience of description, descriptions will focus on LiDAR.

The vehicle control apparatus 100 according to an example may include the LiDAR 120 that obtains a plurality of points based on a pulse laser signal. For example, the LiDAR 120 may obtain datasets obtained by identifying objects surrounding the vehicle control apparatus 100 (or a vehicle including the vehicle control apparatus 100). For example, the LiDAR 120 may identify at least one of a location of the surrounding object, a movement direction of the surrounding object, or the speed of the surrounding object, or any combination thereof based on the pulse laser signal emitted from the LiDAR 120 being reflected and returned by the surrounding object (e.g., a nearby vehicle, a pedestrian, a tree, or a building, etc.).

For example, the LiDAR 120 may obtain datasets for expressing an external object in the space defined by an x-axis, a y-axis, and a z-axis based on a pulse laser signal reflected from surrounding objects. For example, the LiDAR 120 may obtain datasets including a plurality of points in the space, which is formed by the x-axis, the y-axis, and the z-axis, based on receiving the pulse laser signal at a designated period (e.g., every 100 milliseconds, every sensor frame, or at a refresh rate of 10 Hz, etc.). For example, the plurality of points may include points representing an external object within a three-dimensional virtual coordinate system. The three-dimensional virtual coordinate system may include at least one of a vehicle coordinate system, or a LiDAR coordinate system, or any combination thereof. However, an example of the three-dimensional virtual coordinate system is not limited to those described above (e.g., it may include a world coordinate system or a map-based coordinate system, etc.).

The memory 130 of the vehicle control apparatus 100 according to an example may include a hardware component for storing data and/or instructions that are to be input and/or output to the processor 110 of the vehicle control apparatus 100. For example, the memory 130 may include a volatile memory including a random-access memory (RAM), and/or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof. For example, the non-volatile memory includes at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof (e.g., depending on cost, size, write endurance, or access speed, etc.).

One or more instructions indicating an arithmetic operation and/or an operation to be performed on data by the processor 110 of the vehicle control apparatus 100 may be stored in the memory 130 of the vehicle control apparatus 100. A set of one or more instructions may be referred to as a “program”, “firmware”, an “operating system”, a “process”, a “routine”, a “sub-routine”, and/or an “application” (e.g., an object detector, a SLAM module, or a LiDAR segmentation engine, etc.).

Hereinafter, the fact that an application is installed in the vehicle control apparatus 100 may mean that the one or more instructions provided in a form of an application are stored in the memory 130, and may mean that one or more applications are stored in a format (e.g., a file with an extension specified by the operating system of the vehicle control apparatus 100) executable by the processor 110 of the vehicle control apparatus 100 (e.g., a binary executable file, or a compiled library, etc.).

For example, the memory 130 may include a first neural network model for detecting an object. For example, the memory 130 may include a second neural network model for outputting the types of the plurality of points obtained by the LiDAR 120, and/or scores of the plurality of points (e.g., object class scores or distance likelihoods, etc.).

In an example, the processor 110 may obtain at least one of a first virtual box representing a target object, or a first class representing the type of the target object, or any combination thereof based on the plurality of points obtained through the LiDAR 120 and the first neural network model stored in the memory 130.

For example, the processor 110 may obtain at least one of the first virtual box representing the target object, or the first class representing the type of the target object, or any combination thereof based on inputting the plurality of points to the first neural network model. For example, the first neural network model may include an object detection model (e.g., a 3D bounding box detector or a center-based detection network, etc.). For example, the target object may include an external object placed within a specified distance from the vehicle control apparatus 100 (or a host vehicle including the vehicle control apparatus 100) (e.g., within a 50-meter range in the forward direction, etc.). For example, the target object may include an object that is identified by the vehicle control apparatus 100 and is continuously tracked. For example, the type of the target object may include a plurality of types for classifying the target object. For example, the type of the target object may include at least one of a first type representing the ground, or a second type representing a type different from the ground, or any combination thereof. The type of the target object is not limited to the examples described above. For example, the type of the target object may include, but is not limited to, at least one of a third type representing a person, or a fourth type representing a vehicle, or any combination thereof (e.g., a bicycle, a traffic cone, a tunnel wall, or a construction sign, etc.).

In an example, the processor 110 may obtain at least one of first partial points corresponding to at least part of the target object among the plurality of points, or a second class identified by the first partial points and representing the type of the target object, or any combination thereof based on the plurality of points and a second neural network model. For example, the second neural network model may include a segmentation model (e.g., a range-view CNN, a point-based classifier, or a sparse voxel network, etc.).

For example, the second neural network model may include a neural network model for obtaining the types of the plurality of points and scores of the plurality of points (e.g., softmax outputs, probability heatmaps, or class activation scores, etc.).

For example, the processor 110 may obtain the first partial points corresponding to at least part of the target object among the plurality of points based on inputting the plurality of points to the second neural network model. For example, the processor 110 may identify the types of the plurality of points based on inputting the plurality of points to the second neural network model. For example, the processor 110 may obtain the first partial points corresponding to at least part of the target object among the plurality of points based on the type of each of the plurality of points (e.g., classifying some points as belonging to a vehicle, pedestrian, or roadside object, etc.).

In an example, the processor 110 may perform a first specified algorithm on the plurality of points. For example, the processor 110 may perform the first specified algorithm for classifying the type of each of the plurality of points on the plurality of points, for example, within the LiDAR data frame. For example, the processor 110 may classify second partial points corresponding to a specified type among the plurality of points. For example, the specified type may include a type representing the ground (e.g., pavement, crosswalks, or flat surfaces, etc.).

For example, on the basis of performing the first specified algorithm on the plurality of points, the processor 110 may obtain (or identify) the first partial points by classifying the second partial points corresponding to the specified type and excluding the second partial points from the plurality of points (e.g., separating above-ground structures from terrain, etc.).

In an example, the processor 110 may obtain at least one of a partial class for obtaining the second class, or a score of each of the plurality of points, or any combination thereof based on inputting the plurality of points to the second neural network model. For example, the processor 110 may obtain the partial class and the score of each of the plurality of points based on inputting the plurality of points to the second neural network model. For example, the partial class may include classifying the plurality of points based on an arbitrary type (e.g., tree, vehicle, pedestrian, or unknown, etc.).

For example, the processor 110 may fuse the partial class, the score of each of the plurality of points, and the second partial points (e.g., for joint feature enhancement or confidence weighting, etc.). For example, the processor 110 may perform clustering based on fusing the partial class, the score of each of the plurality of points, and the second partial points. For example, the clustering may include grouping the first partial points corresponding to at least part of the target object (e.g., to generate an instance-level region for bounding box generation, etc.).

For example, the processor 110 may obtain a point cloud for generating a second virtual box based on the first partial points. For example, the processor 110 may obtain the point cloud based on grouping the first partial points (e.g., using spatial proximity, density thresholding, or Density-Based Spatial Clustering of Applications with Noise (DBSCAN), etc.).

For example, the processor 110 may generate the second virtual box, which is different from the first virtual box and represents the target object, based on the point cloud. For example, the second virtual box may include a box including at least some of the first partial points (e.g., tightly fitted to the object's spatial extent, etc.).

For example, the processor 110 may identify a heading direction indicating a traveling direction of the target object based on at least one of the first partial points, or the point cloud, or any combination thereof (e.g., using temporal point shifts or bounding box orientation, etc.).

For example, the processor 110 may identify the location of the second virtual box in the virtual coordinate system based on at least one of the first partial points, or the point cloud, or any combination thereof (e.g., by computing the centroid of the clustered points, using a bounding box anchor, or referencing vehicle-relative coordinates, etc.). For example, the processor 110 may identify the size of the second virtual box based on at least one of the first partial points, or the point cloud, or any combination thereof (e.g., by estimating width, height, and depth based on point dispersion or statistical spread, etc.). For example, the processor 110 may identify the second class based on at least one of the first partial points, or the point cloud, or any combination thereof (e.g., classifying as car, pedestrian, traffic cone, or unknown, etc.). For example, the processor 110 may identify at least one of a heading direction indicating a traveling direction of the target object, a location of a second virtual box in a virtual coordinate system, a size of the second virtual box, or a second class, or any combination thereof based on at least one of the first partial points, or the point cloud, or any combination thereof (e.g., to aid in trajectory prediction, collision risk estimation, or classification confidence, etc.). For example, the processor 110 may identify the heading direction of a bounding box based on at least one of the first virtual box, the first class, the heading direction of the second virtual box, the location of the second virtual box, the size of the second virtual box, or the second class, or any combination thereof (e.g., by tracking box orientation over time, using direction vectors, or aligning with lane markings, etc.). For example, the processor 110 may identify the location of a bounding box in a virtual coordinate system based on at least one of the first virtual box, the first class, the heading direction of the second virtual box, the location of the second virtual box, the size of the second virtual box, or the second class, or any combination thereof (e.g., using Kalman filtering, relative coordinate mapping, or GPS reference data, etc.). For example, the processor 110 may obtain a third class representing the type of the target object corresponding to the bounding box based on at least one of the first virtual box, the first class, the heading direction of the second virtual box, the location of the second virtual box, the size of the second virtual box, or the second class, or any combination thereof (e.g., refining classification using fusion from multiple frames, object hierarchy rules, or semantic context, etc.). For example, the processor 110 may obtain at least one of the heading direction of the bounding box, the location of the bounding box in the virtual coordinate system, or the third class indicating the type of the target object corresponding to the bounding box, or any combination thereof based on at least one of the first virtual box, the first class, the heading direction of the second virtual box, the location of the second virtual box, the size of the second virtual box, or the second class, or any combination thereof (e.g., for generating object tracks, scene graphs, or vehicle control cues, etc.).

For example, the processor 110 may assign a first identifier to the second virtual box for tracking the second virtual box (e.g., a unique ID based on timestamp, class, or location hash, etc.). For example, the processor 110 may assign a second identifier corresponding to the first identifier to a bounding box (e.g., to maintain identity consistency between detection and tracking outputs, etc.).

For example, the processor 110 may track the bounding box by using the second identifier. For example, the processor 110 may track a target object based on identifying, in a plurality of frames, a plurality of bounding boxes including the bounding box to which the second identifier is assigned (e.g., through temporal association or object re-identification, etc.). For example, because the second identifier is an identifier assigned to the bounding box corresponding to the target object, the processor 110 may track the target object by identifying a plurality of bounding boxes, to which the second identifier is assigned, in a plurality of frames (e.g., over multiple sensor cycles or time steps, etc.).

In an example, the processor 110 may output the bounding box corresponding to the target object based on at least one of the first virtual box, the first class, the first partial points, or the second class, or any combination thereof (e.g., as a hexahedral 3D box, 2D projected box, or directional polygon, etc.). For example, a bounding box may include an example of the target object expressed in a virtual coordinate system in the form of a hexahedron (e.g., defined by eight corner points in 3D space, etc.).

Hereinafter, operations performed by a CPU, a GPU, and/or an NPU included in the processor 110 are briefly described.

In an example, the processor 110 may include at least one of the CPU, the GPU, or the NPU, or any combination thereof. For example, at least one of the GPU, or the NPU, or any combination thereof may obtain the first virtual box and the first class based on the first neural network model (e.g., a region proposal network, transformer-based model, or YOLO-like detector, etc.). For example, at least one of the GPU or the NPU may obtain the first virtual box and the first class. For example, at least one of the GPU, or the NPU, or any combination thereof may obtain a score for each of the plurality of points and a partial class for obtaining the second class based on the second neural network model. For example, at least one of the GPU or the NPU may obtain the score of each of the plurality of points and the partial class for obtaining the second class based on the second neural network model (e.g., probability distributions over semantic labels, etc.). For example, the CPU may classify the second partial points corresponding to a specified type among the plurality of points based on performing the first specified algorithm for classifying the type of each of the plurality of points on the plurality of points (e.g., such as distinguishing ground, non-ground, or noise points, etc.).

As described above, the vehicle control apparatus 100 according to an example may include at least one processor 110. The vehicle control apparatus 100 may accurately detect the target object by detecting the target object by using the at least one processor 110. Furthermore, the vehicle control apparatus 100 may reduce the load on each processor by performing parallel processes (e.g., enabling real-time LiDAR segmentation and object tracking, etc.).

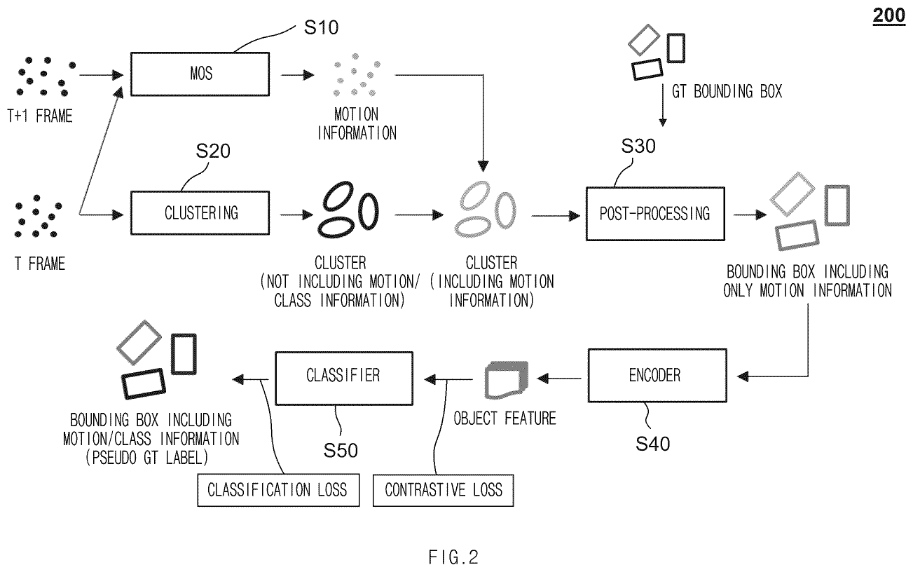

Before referring to FIG. 2, for a general understanding of AI object recognition according to an example of the present disclosure, descriptions related to LiDAR-based object recognition is added as follows.

The object recognition process by the LiDAR 120 and the AI module goes through three stages: pre-processing, segmentation, and tracking. For example, AI module may include and execute one or more AI models (e.g., neural networks) for preprocessing, segmentation, and tracking (e.g., detecting road surfaces, identifying vehicle outlines, or following pedestrian movement, etc.).

An object recognition system 1000 according to an example of the present disclosure goes through a pre-processing process before executing an object recognition function. The pre-processing may include an operation of removing points forming the ground based on laser sensing data (i.e., raw data not processed) input from the LiDAR 120. Because the laser beam reflected from the ground may be misrecognized as though there is an object on the ground, a process of distinguishing between the ground and non-ground may be performed in the pre-processing stage. As needed, the process may also be performed in the segmentation stage.

For example, in AI object recognition, the pre-processing may be understood as a process in which an image processing tool of the AI module in the processor 110 removes noise from a LiDAR point cloud image and reduces the total number of points being present in the LiDAR point cloud image through a voxel downsampling technique to improve computational efficiency.

For reference, the LiDAR point cloud image may also be displayed in a bird's eye view (BEV) mode. When a LiDAR map is created to resemble the scene as seen through a bird's eye when a bird watches a city center while a bird flies overhead, the LiDAR map is called a BEV image (e.g., top-down views showing roads, vehicles, curbs, or crosswalks, etc.).

In other words, as described above, the LiDAR 120 generates a point for each of the numerous laser signals and calculates a distance to the point, by sending a laser beam out into environments and recording the time at which the laser beam is reflected from an object outside the environments and then is returned. The processor 110 may create a real-time LiDAR map of the surrounding environment as a BEV-type 3D map, or as a 2D map as needed (e.g., for simplified planning, navigation, or pedestrian zone detection, etc.), by repeatedly sending out a lot of laser beams in this way.

The lines or areas that appear in black and white on a LiDAR point cloud map are actually composed of countless points (each of the points is generated by the laser beam of the LiDAR 120), which is why the LiDAR sensing image is also called the LiDAR point cloud image. Of course, for example, when an RGB-D (Red, Green, Blue-Depth) sensor and a LiDAR sensor are combined, the LiDAR point cloud image may be recreated in color (e.g., to distinguish road markings, traffic signs, or construction cones, etc.).

It is difficult for humans to perceive objects with a lot of points in the LiDAR point cloud image. However, when comprehensively looking at a point cloud from a BEV perspective or in a method such as a two-dimensional plan, humans may roughly guess what the surroundings of the vehicle currently driving autonomously look like. Furthermore, for example, various types of objects (e.g., vehicles, buses, pedestrians, street trees, traffic signs, or a construction cone, etc.) that are present in the LiDAR point cloud image may be recognized. In an AI image recognition technology, these things or people are called objects. Each object may be classified into classes belonging to a group with specific characteristics, such as a vehicle class, a bus class, pedestrian class, traffic light class, or barrier class, etc.

Identifying a class of an object such as a vehicle class, a bus class, and the like in the LiDAR point cloud image requires the help of a deep AI neural network. To find objects in the LiDAR point cloud image through an AI neural network and to identify classes of the objects, AI training needs to be performed first.

For example, a dataset called PANDASET™ includes over 48,000 camera images (mostly taken in the Silicon Valley area in the United States) and over 16,000 LiDAR scan images, which are annotated with 28 classes, including pedestrians, passenger cars, bicycles, construction site signs, and traffic signs.

Moreover, the LiDAR point cloud image may be visualized to suit a user's desired options by using point cloud task tools such as Open3D™. Because the LiDAR 120 is capable of detecting a distance, 3D LiDAR images may be realistically reproduced in visual processing with Open3D™, for example, in a method in which objects farther away are colored in dark blue, and objects closer are colored in light blue (e.g., rendering distant trees in blue and nearby vehicles in bright blue, etc.).

Furthermore, as mentioned above, the original LiDAR image (i.e., raw data) may be pre-processed by applying a technique called voxel (three-dimensional pixel) downsampling to the LiDAR point cloud image. Here, the voxel refers to a cube-shaped 3D pixel. The voxel downsampling is a technique for reducing the number of points in the LiDAR point cloud without requiring excessive AI computation while the structure of the various objects in the cloud is preserved.

For example, the LiDAR 120 emits ‘m’ laser beams ‘n’ times during one scan cycle. In this case, scan values of the laser beams that collide with an external object and return form an m×n matrix. Data of the m×n matrix is called a range image. Each point constituting the LiDAR point cloud image includes depth (i.e., range) information, and also includes the intensity, azimuth, and inclination of the returned laser pulse and other additional information (e.g., reflectivity, return number, or time-of-flight, etc.). For range images, AI training is possible by using large datasets such as Waymo™ Open Dataset (WOD), for example.

In short, range view (RV) is a technique that converts a three-dimensional point cloud into a two-to two-and-a-half-dimensional scene, and represents the converted result as a LiDAR three-dimensional map that humans is capable of intuitively understanding like an analog painting instead of a lot of dots (e.g., as a panoramic image showing lane boundaries and obstacles in a simplified layout, etc.). In the range view image, the 3D LiDAR point cloud image includes 2D coordinates. However, the 3D laser-related information (an angle, an inclination, intensity, or the like) recorded when the range image is obtained is not discarded. When one coordinate of one 2D axis is obtained by applying a variable of a width to coordinates (x, y) among coordinates (x, y, z) of the 3D LiDAR image, and the other coordinate of the other 2D axis is obtained by applying a variable of a height and range image information indicating a range (depth) to coordinate (z), a 2D range view image is created (e.g., mapping lateral position to image width and vertical angle or elevation to image height, etc.).

In addition, the AI algorithm according to an example of the present disclosure may include a convolutional neural network (CNN). The CNN is an AI training module frequently used to extract features (or feature points) from image data (e.g., edges, corners, textures, or object outlines, etc.). To this end, there are commercially available datasets composed of tens of thousands of images. The CNN may have a version capable of processing images from 1D to 3D (e.g., 1D for signal patterns, 2D for camera images, or 3D for LiDAR voxel grids, etc.). For example, the results of a range view image processing tool are trained by the CNN to perform a function of helping AI accurately recognize an object in an image.

Because an object around an autonomous vehicle is finally recognized by a machine, creation of a ground truth (GT) bounding box on the aforementioned LiDAR map is also an important process in object recognition. In machine learning, the GT is a term used to indicate an original value or an actual value of data to be trained by the AI (e.g., the real position of a pedestrian, car, or traffic cone, etc.). It may be a type of image annotation applied to the LiDAR point cloud image as a bounding box usually with a box-shaped boundary.

For example, to recognize an object, the AI module fetches a label and then groups various objects (e.g., grouping multiple detected vehicles into a vehicle class or pedestrians into a pedestrian class, etc.). Of course, an interval between 3D data points used to output a GT bounding box may also be set. One GT bounding box may be set to include 50 to 1000 LiDAR cloud points (e.g., depending on the object's size or scan density, etc.).

Of course, such the GT annotation is not present in raw data captured by a sensor such as the LiDAR 120 while a vehicle is driving. The processor 110 needs to recognize a target belonging to various classes such as road signs, crosswalks, pedestrians, another vehicle, a center line, or a guardrail, etc., as an object. The GT annotation is a means used to measure object recognition errors by comparing the object determination results recognized by the AI algorithm of the processor 110 with an actual object and to sometimes evaluate AI performance. The GT bounding box applied to an original image in an annotation form may be set manually by a user, but there are also commercially available GT calculation tools, such as grid-striding (e.g., dividing a space into grid cells and labeling each cell's contents, etc.).

When an AI object recognition module is executed, the predicted bounding box may also be identified. The result recognized by the processor 110 as an object of a specific class from the original image data obtained from the LiDAR sensor 120 is displayed in the shape of another bounding box similar to the GT bounding box. The predicted bounding boxes, unlike GT bounding boxes, are the computational results of autonomous driving AI. The predicted bounding box may match the GT bounding box, but there may be an area that does not match or overlap the GT bounding box at all (e.g., due to sensor noise, occlusion, or misclassification, etc.).

For reference, only the predicted bounding boxes may not definitively determine whether an object of a specific class is actually present at a specific location, and thus the predicted bounding boxes are usually called probability boxes (P-Boxes) or predicted bounding boxes.

For example, segmentation processing performed after pre-processing refers to displaying a specific part of a road (e.g., a traffic light) in red and the rest (an asphalt road) in blue (e.g., for class-based color labeling, etc.). Clustering a point cloud into specific groups and generating P-Box may also be performed at the segmentation stage. For reference, there is also a technique called cluster expansion. Here, an expansion target may include a cluster from a seed point to all points within an epsilon distance (a minimum distance for forming a cluster) (e.g., expanding a group of adjacent car-surface points into a full vehicle object, etc.).

During the segmentation processing, P-Box creation and clustering based on the point cloud are performed. For example, the AI network performing segmentation is used to obtain a point label from the LiDAR sensor 120 (e.g., labeling a point as road, curb, or obstacle, etc.).

To solve a ground recognition error occurring during the segmentation, the present disclosure proposes a “rule-based” ground recognition and label fusion technique. Any of various techniques such as slope-based ground recognition, grid-based ground recognition, or other non-planar-based ground recognition may be applied as the ground recognition algorithm (e.g., for detecting curved ramps, uneven terrain, or multi-elevation surfaces, etc.). However, in an example of the present disclosure, it is proposed that the slope-based ground recognition technique is to be adopted when the ground inside a tunnel is recognized.

For reference, semantic segmentation refers to a task of assigning a unique class label to each point in the point cloud generated by the LiDAR 120. In the LiDAR image processing technology, the semantic segmentation is a technology that finds and uses meaningful information from LiDAR data for object recognition and scene reproduction, which are necessary for implementing autonomous driving (e.g., identifying roads, sidewalks, vehicles, or vegetation, etc.). Various semantic segmentation AI models such as a projection-based method, a point-based method, and a sparse convolution-based method may be applied. For example, the semantic segmentation result may be the result of AI computation performed by the processor 110 and NVIDIA DRIVE™ AGX system. With this configuration, for example, various colors may be added to the LiDAR point cloud image (e.g., coloring vehicles in red, pedestrians in yellow, or road surfaces in gray, etc.).

After the segmentation process as above, the LiDAR image goes through a post-processing process. The post-processing refers to converting point cloud data into a 3D map or a model, to extract information for autonomous driving. The post-processing also includes a process of finally removing noise and errors from a LiDAR point cloud image, recognizing an object such as a vehicle or a pedestrian from the point cloud, and attaching and registering a unique identifier to point cloud information as necessary (e.g., for object tracking, localization, or scene mapping, etc.).

FIG. 2 shows an example of an algorithm 200 for extracting, inferring, and classifying features of a target object through MOS and contrastive learning, according to an example of the present disclosure.

Referring to FIG. 2, in an example of the present disclosure, training processes may be divided into three modules: (i) a pre-trained module used for ground estimation and removal of unnecessary points and for MOS, (ii) a non-trained module for clustering and filtering, and (iii) a trainable module including an encoder and a classifier (e.g., a convolutional neural network, a recurrent neural network, a transformer-based encoder, or a support vector machine, etc.).
(i) First of all, the pre-trained module performs ground estimation and removes unnecessary points as a pre-processing step before processing a point cloud. This is to leave only points associated with a target object (e.g., a vehicle, a pedestrian, a traffic light, or a bicycle, etc.).

In the case of the ground estimation and point removal, an algorithm is performed to estimate points corresponding to the ground from original point cloud data. In this case, a pre-trained deep learning-based model or a rule-based model using a normal vector may be utilized. For example, the rule-based methodology calculates the normal vector of the point cloud, converts points into a reference coordinate system by using a calibration result value, and performs ground estimation by combining a height (i.e., z value) and an average value of the normal vector (e.g., to exclude road surfaces, sidewalks, ramps, or other planar ground structures, etc.).

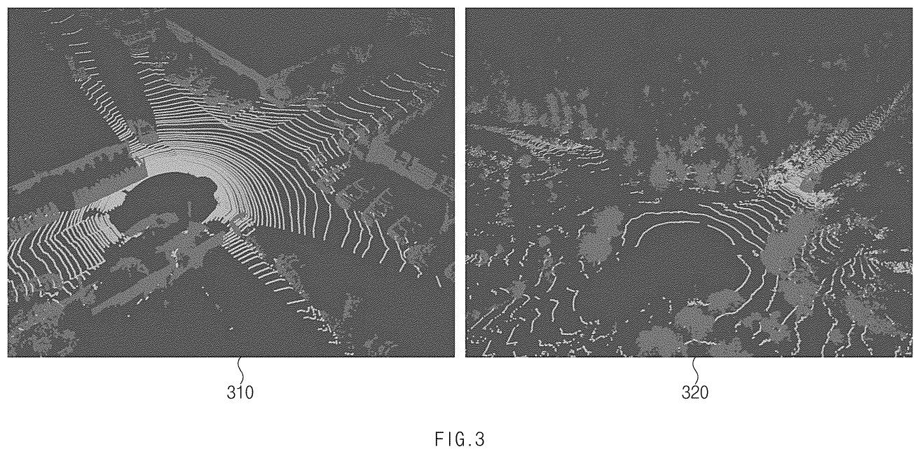

FIG. 3 shows an example 300 of recognizing the ground, according to an example of the present disclosure. In two examples 310 and 320, green marks are portions in which the ground is estimated (e.g., flat road segments, parking lot surfaces, or paved walkways, etc.).

MOS of S10 in FIG. 2 may be a method of classifying points corresponding to objects with motion when a point cloud sequence is given, and may estimate scene flow or apply methods such as dynamic-awareness mapping. For example, overall matching may be performed by using ICP between consecutive frames. Afterwards, points still including a large error may be determined to be moving objects. When mapping is performed, areas where occupied/unoccupied states are present simultaneously, or points where objects are located may be considered as being non-static. In particular, the MOS algorithm according to an example of the present disclosure selects a self-supervised learning (SSL) model based on nearest neighbor points among learning-based or non-learning-based methods (e.g., ICP-based segmentation, occupancy grid mapping, scene flow analysis, or temporal correlation, etc.).

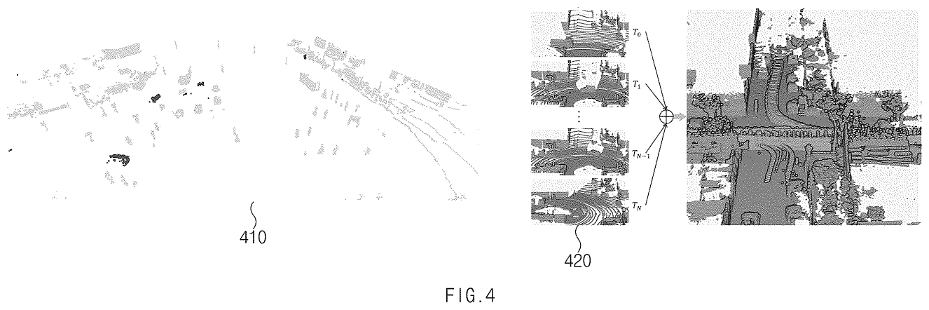

FIG. 4 shows an example of a MOS result 400 based on an iterative closest point (ICP) or mapping, according to an example of the present disclosure. Reference numeral 410 indicates the ICP-based segmentation result, and reference numeral 420 indicates the mapping-based segmentation result (e.g., segmentation of moving pedestrians, moving cars, or shifting bicycles, etc.).
(ii) A non-learning module is a portion where the distinction between dynamic points and static points is performed by using the pre-trained method described above, and then classification is performed on an object unit, not a point unit, for object recognition. In this case, an unsupervised learning-based clustering algorithm is used (e.g., DBSCAN, K-means, hierarchical clustering, or Gaussian mixture clustering, etc.).

The above-described clustering is performed by using an unsupervised learning-based algorithm capable of extracting a cluster from a point cloud. The number of objects recognized in autonomous driving situations is variable, and thus it is preferable to use a density-based clustering algorithm rather than K-Nearest Neighbor (KNN). For example, when clusters related to 3D objects are built based on the density of points by using a 3D Density-Based Spatial Clustering of Applications with Noise (DBSCAN) clustering algorithm, data structures regarding points and grid trees are required. The dynamic number of clustering is possible when the DBSCAN is applied. 3D classification tools such as POINTNET™ may also be utilized when the DBSCAN is applied. Moreover, as in S220 of FIG. 2, the algorithm may include a Knowledge Distillation (KD) tree structure (e.g., KD-trees, octrees, or voxel-based spatial partitioning, etc.).

Afterwards, results in the form of a predicted bounding box (P-Box) may be finally output by applying the post-processing technique of S30 to the cluster generated in S20 of FIG. 2. To ensure P-Box ground contact constraints, a pattern matching technique may be used to match predefined patterns (e.g., rectangular templates, cylindrical templates, or vehicle-specific patterns, etc.). However, class information of clusters may not be identified through this result.

The filtering among the non-learning modules is performed for detailed class classification. In other words, dynamic or static bounding boxes may be obtained by combining the results of MOS and clustering. However, whether the bounding box corresponds to a target object for GT generation (e.g., the class of a dynamic or static bounding box (whether it is a dynamic vehicle, a dynamic pedestrian, a static building, or the like)) may not be determined. Accordingly, a filtering process is performed to split dynamic or static bounding boxes into three classes, for example, dynamic-object bounding boxes, static-object bounding boxes, or non-target-object bounding boxes, by using GT bounding boxes to provide detailed class information.

First, a class for the P-Box is specified by calculating the overlap area between the GT bounding box and the P-Box. The result of the filtering may include information about whether it is a dynamic object (a moving vehicle) or a static object (a stationary vehicle) as the target object, and may also include information about other uninteresting objects (e.g., buildings, fences, traffic cones, streetlights, or billboards, etc.).

For reference, the present disclosure proposes to use a binary classification technique that divides objects into two types, “target” and “others,” as a default setting to maximize the auto labeling performance. However, when the amount of GT data used for learning is sufficient, it doesn't matter when the multi-class classification method is applied (i.e., the first target, the second target, . . . , the N-th target, background objects, or other classes, etc.).
(iii) The trainable module is a process of removing GT dependency. For example, three types of bounding boxes are obtained by using GT: dynamic objects, static objects, and other objects (e.g., pedestrians, bicycles, trucks, or trees, etc.). However, the dependency on GT may be removed to generate pseudo GT bounding boxes. Accordingly, there is a need for a trainable model that receives a cluster belonging to dynamic/static/other types and extracts and classifies features to determine whether the cluster corresponds to the target object.

To this end, there is a need to train the encoder in S40, which may extract features to identify clusters belonging to each of the dynamic/static/other types, and the classifier in S50 that may identify each class by using the extracted features (e.g., whether the cluster corresponds to a moving car, a stationary car, a pedestrian, or a background object, etc.).

In S40, an encoder receives points belonging to each cluster and extracts a latent feature vector. In the present disclosure, the encoder adopts an artificial neural network structure capable of handling a point cloud input (e.g., PointNet, a multi-layer perceptron, or other point cloud feature extractors, etc.).

In particular, the present disclosure proposes to use a PointNet or Multi-Layer Perceptron (MLP)-based model including rotation-agnostic properties. The reason is that when a model other than PointNet or MLP is used, an augmentation procedure needs to be added to respond to changes in the heading of an object (e.g., a vehicle rotated at 45°, a pedestrian turned sideways, or a bicycle leaning, etc.).

Clusters respectively belonging to dynamic/static/other types are passed through the encoder of S40 and converted into “features” respectively belonging to dynamic/static/other types. However, the extracted features need to be discriminative enough to identify each class. Accordingly, as a way to effectively improve discrimination, the present disclosure proposes to apply contrastive learning techniques. In other words, a loss function is applied such that dynamic and static features are similar to each other, and a loss function is designed such that feature vectors belonging to the same class are close to each other. However, the loss function is set such that dynamic/static features and other features are farther away from each other (e.g., separating moving pedestrians from trees, moving vehicles from traffic lights, or static guardrails from dynamic bicycles, etc.).

The classifier of S50 performs a classification task using a “feature” belonging to each of the dynamic/static/other types, with enhanced discrimination power through contrastive learning (e.g., correctly identifying that a cluster corresponds to a moving car, a stationary building, or an irrelevant background structure, etc.).

To this end, first of all, dynamic/static features and other features are identified. ‘1’ may be assigned to the dynamic/static features as the meaning of the target object, and ‘0’ may be assigned to the other features as the meaning of the other object. In particular, class prediction is possible by adding an objective function to the classifier of S50. Accordingly, by using this, whether the cluster given as input is a target cluster or another cluster may be identified without a GT bounding box in a step of generating the pseudo GT (e.g., automatically labeling a moving bus, a stationary car, or ignoring a background fence, etc.).

According to the algorithm 200 of the present disclosure illustrated in FIG. 2, the features of a target object may be effectively extracted and classified by using a small number of GT bounding box data based on MOS and contrastive learning techniques (e.g., correctly handling cases involving cars, pedestrians, bicycles, or traffic barriers, etc.).

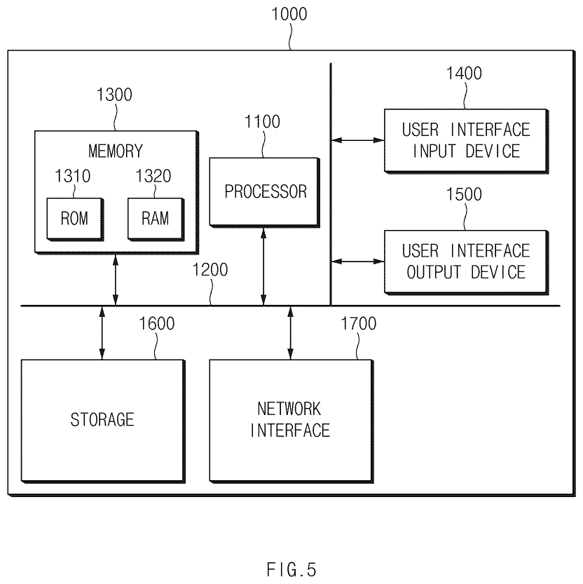

FIG. 5 shows an example of a computing system 1000 for autonomous vehicle control and object recognition operations, according to an example of the present disclosure.

Referring to FIG. 5, the computing system 1000 may include at least one processor 1100, a memory 1300, a user interface input device 1400, a user interface output device 1500, storage 1600, and a network interface 1700, which are connected with each other via a bus 1200 (e.g., a PCIe bus, a system-on-chip (SoC) interconnect, or a USB-based communication channel, etc.).

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM) (e.g., DRAM, SRAM, or LPDDR memory, etc.).

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM) (e.g., an SSD, a microSD card, or a Blu-ray disc, etc.).

The storage medium may be coupled to the processor 1100. The processor 1100 may read out information from the storage medium and may write information in the storage medium. Alternatively, the storage medium may be integrated with the processor 1100. The processor and the storage medium may be implemented with an application specific integrated circuit (ASIC) (e.g., a custom-designed AI accelerator, an automotive-grade chip, or a mobile SoC, etc.). The ASIC may be provided in a user terminal (e.g., a smartphone, a vehicle-mounted device, or an industrial robot controller, etc.). Alternatively, the processor and the storage medium may be implemented with separate components in the user terminal (e.g., a CPU connected to a discrete GPU and a separate DRAM module, etc.).

According to an example of the present disclosure, a system for recognizing an object by using an AI module and an autonomous driving sensor includes a processor equipped with an object recognition module that recognizes an object placed in a surrounding environment from pieces of point data input from the autonomous driving sensor as a part of the AI module, and a memory that stores the input pieces of point data. The AI module performs a first step of generating a cluster including motion information by performing moving object segmentation (MOS) and a clustering operation from the pieces of point data, a second step of generating a bounding box, which includes the motion information, and includes classification information about a dynamic object, a static object, or another object, through post-processing based on the cluster including the motion information, and a third step of extracting a feature for determining whether the cluster including the motion information corresponds to a target object, based on the bounding box and generating a 3D pseudo GT bounding box by using an unlabeled point cloud frame through a classifier based on contrastive learning.

In the case of a target object extracting system according to the second example of the present disclosure, the first step includes a ground estimation process and a process of removing a point irrelevant to the target object.

In the case of a target object extracting system according to the third example of the present disclosure, the ground estimation process is performed by a pre-trained deep learning-based model or a rule-based model using a normal vector.

In the case of a target object extracting system according to the fourth example of the present disclosure, the MOS of the first step is performed based on an iterative closest point (ICP) between consecutive frames input from the autonomous driving sensor, or based on mapping based on an occupied or unoccupied state.

In the case of a target object extracting system according to the fifth example of the present disclosure, an AI self-supervised learning technique based on a nearest neighbor point is applied to the MOS.

In the case of a target object extracting system according to the sixth example of the present disclosure, the second step includes an unsupervised learning-based clustering process.

In the case of a target object extracting system according to the seventh example of the present disclosure, the unsupervised learning-based clustering process is performed by a 3D density-based spatial clustering of applications with Noise (DBSCAN) clustering algorithm.

In the case of a target object extracting system according to the eighth example of the present disclosure, the second step includes a binary filtering process of performing class classification on whether the cluster including the motion information is the target object, or whether the cluster including the motion information is another object, not the target object.

In the case of a target object extracting system according to the ninth example of the present disclosure, the binary filtering process is a filtering process of performing class classification on the dynamic object and the static object as the target object, and performing class classification on an object, not the target object, as another object by combining results of the unsupervised learning-based clustering process and the MOS.

In the case of a target object extracting system according to the tenth example of the present disclosure, in the third step, a feature for determining whether the cluster including the motion information corresponds to the target object is extracted by an encoder with a rotation agnostic property.

According to an example of the present disclosure, a method for recognizing an object by pieces of point data from an AI module and an autonomous driving sensor includes a first step of generating, by the AI module, a cluster including motion information by performing MOS and a clustering operation from the pieces of point data, a second step of generating a bounding box, which includes the motion information, and includes classification information about a dynamic object, a static object, or another object, through post-processing based on the cluster including the motion information, and a third step of extracting a feature for determining whether the cluster including the motion information corresponds to a target object, based on the bounding box and generating a 3D pseudo GT bounding box by using an unlabeled point cloud frame through a classifier based on contrastive learning.

The above description is merely an example of the technical idea of the present disclosure, and various modifications and variations may be made by one skilled in the art without departing from the essential characteristics of the present disclosure.

Accordingly, examples of the present disclosure are intended not to limit but to explain the technical idea of the present disclosure, and the scope and spirit of the present disclosure are not limited by the above examples. The scope of protection of the present disclosure should be construed in accordance with the attached claims, and all equivalents thereof should be construed as being included within the scope of the present disclosure.

The present disclosure proposes a model that is capable of extracting and classifying features of a target object, which is a target of pseudo-GT generation, from a ground truth (GT) for object detection labeled by a human, using a moving object segmentation (MOS) and contrastive learning algorithm (e.g., labeling vehicles, people, signs, or background obstacles, etc.).

An object detection/recognition technology is studied as an essential element for the development of safe autonomous driving technology. Unlike two-dimensional (2D) object detection mainly studied with the development of a camera-based technology, in the case of three-dimensional (3D) object detection, technology development using various sensors such as cameras and LiDAR is possible, and compared to the 2D object detection, the 3D object detection may provide more effective information for autonomous driving (e.g., allowing detection of distance, object shape, relative speed, or occluded objects, etc.).

In most cases of 3D object detection, technological advancements are made using AI supervised learning, but to execute supervised learning, a person needs to create GT on an original point cloud by directly using a specific tool. Moreover, to generalize the performance of an object detection model, a plurality of GTs are generated in consideration of various situations (e.g., daytime, nighttime, rainy weather, fog, or heavy traffic, etc.).

There are various methods for generating GTs for AI training for 3D object detection. As a representative example, there is a method in which a person manually creates a GT based on the point cloud. The method may provide the highest accuracy and the lowest error probability, but result in a very slow GT generation speed and low GT generation efficiency per single frame (e.g., manually labeling vehicles, pedestrians, bicycles, or traffic lights, etc.). Furthermore, there is also the possibility of human error (e.g., inconsistent labeling between annotators, missed objects, or misaligned bounding boxes, etc.). Also, there is a method of using the inference results of this model as a pseudo GT by using a large object detection (LOD) model. This method includes a fast GT generation speed and low GT generation cost, but has a reliability issue with the inference results of the model, and requires a considerable number of GTs to train a large model with high generalization performance (e.g., requiring tens of thousands of labeled frames for cars, pedestrians, road signs, or buses, etc.). There is a method of using clustering as another knowledge-based method. The method is capable of being used even in situations where there is no GT data at all (e.g., grouping unlabeled LiDAR points into clusters for vehicles, buildings, traffic barriers, or pedestrians, etc.). However, the method may show a large difference in performance depending on the parameter tuning of a clustering algorithm, and it is necessary to utilize patterns defined by humans in advance for the purpose of determining the class of each cluster (e.g., distinguishing between cars, pedestrians, lampposts, traffic signs, or bicycles, etc.).

Given the limitations of the aforementioned methods, the technical challenge of the present disclosure is to present a model capable of effectively extracting features of a target object of interest from a small number of GTs and classifying target/non-target objects using MOS and contrastive learning techniques (e.g., for labeling dynamic vehicles, dynamic pedestrians, static roadside structures, or irrelevant clutter, etc.).

According to an example of the present disclosure, it is possible to assign class information to points, with added motion features (e.g., velocity vectors, displacement estimates, or trajectory predictions, etc.) by using an encoder and a classifier, and to generate a pseudo 3D object detection GT by fusing estimated object information, clusters, and an algorithm. It is possible to effectively extract and classify features of target objects by using a small number of GT bounding box data based on the aforementioned MOS and contrastive learning techniques, and 3D pseudo GT may be generated by using unlabeled point cloud frames (e.g., unlabeled traffic scenes, highway merges, parking lots, or intersections, etc.).

In addition, according to an example of the present disclosure, a pseudo GT may be generated for all frames other than sparsely obtained GT, and this may be utilized to generate pseudo tracking GT in addition to object detection. When available GT data is sufficient, the classifier may also be integrated into a multi-class classifier (e.g., for vehicles, pedestrians, cyclists, traffic signs, or road barriers, etc.).

Furthermore, through the detailed description of the present disclosure and the attached drawings, those skilled in the art may understand various effects other than the effects described above from the present disclosure.

As described above, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus of a vehicle, the apparatus comprising:
a sensor configured to obtain pieces of point data associated with a surrounding environment of the vehicle;
a memory configured to store the pieces of point data; and
a processor circuit configured to:
recognize, based on processing of the pieces of point data using an artificial intelligence model, at least one object in the surrounding environment of the vehicle,
based on performing moving object segmentation (MOS) and a clustering operation on the pieces of point data, generate a cluster, wherein the cluster comprises motion information associated with the at least one object,
based on post-processing the cluster, generate a bounding box, wherein the bounding box comprises the motion information, and
obtain, based on the bounding box, a feature for determining whether the cluster corresponds to a target object of the at least one object,
apply contrastive learning to the obtained feature for generating classification information, wherein the classification information indicates whether the cluster corresponds to a moving object or a static object, and
based on the bounding box, the classification information, and a determination that the cluster corresponds to the target object, generate a three dimensional (3D) pseudo ground truth (GT) bounding box by using an unlabeled point cloud frame.

2. The apparatus of claim 1, wherein the processor circuit is configured to perform a ground estimation process and a process of removing at least one point from the pieces of point data, wherein the at least one point is irrelevant to the target object.

3. The apparatus of claim 2, wherein the processor circuit is configured to perform the ground estimation process based on:
a pre-trained deep learning-based model applied to the pieces of point data, or
a rule-based model that estimates ground points based on normal vectors associated with the pieces of point data.

4. The apparatus of claim 1, wherein the processor circuit is configured to perform the MOS based on:
an iterative closest point (ICP) between consecutive frames of the pieces of point data, or
occupied or unoccupied regions of a map generated from the pieces of point data.

5. The apparatus of claim 1, wherein the processor circuit is configured to perform the MOS by using a self-supervised learning model configured to detect motion based on nearest neighbor points in the pieces of point data.

6. The apparatus of claim 1, wherein the processor circuit is configured to perform an unsupervised learning-based clustering process on the pieces of point data to generate the bounding box.

7. The apparatus of claim 6, wherein the processor circuit is configured to perform the unsupervised learning-based clustering process in three dimensions by grouping points in the pieces of point data that satisfy a point density condition and identifying points that do not satisfy the point density condition as noise.

8. The apparatus of claim 6, wherein the processor circuit is configured to perform a binary classification process to:
determine whether the cluster corresponds to the target object, and
generate the bounding box based on a determination of whether the cluster corresponds to the target object.

9. The apparatus of claim 8, wherein the binary classification process is configured to classify the cluster as:
the target object, wherein the target object corresponds to the moving object or the static object, or
a non-target object, based on the unsupervised learning-based clustering process and the MOS.

10. The apparatus of claim 1, wherein the processor circuit is configured to obtain the feature for determining whether the cluster corresponds to the target object using a feature extraction process, and wherein the feature extraction process is configured to generate features invariant to rotations of the cluster.

11. A method performed by an apparatus of a vehicle, the method comprising:
obtaining, from a sensor, pieces of point data associated a surrounding environment of the vehicle;
based on performing moving object segmentation (MOS) and a clustering operation on the pieces of point data, generating a cluster, wherein the cluster comprises motion information associated with a target object in the surrounding environment of the vehicle;
based on post-processing the cluster, generating a bounding box, wherein the bounding box comprises the motion information;
obtaining, based on the bounding box, a feature for determining whether the cluster corresponds to the target object;
applying contrastive learning to the obtained feature for generating classification information, wherein the classification information indicates whether the cluster corresponds to a moving object or a static object; and
based on the bounding box, the classification information, and a determination that the cluster corresponds to the target object, generating a three dimensional (3D) pseudo ground truth (GT) bounding box by using an unlabeled point cloud frame.

12. The method of claim 11, wherein the generating of the cluster comprises performing a ground estimation process and removing at least one point from the pieces of point data, wherein the at least one point is irrelevant to the target object.

13. The method of claim 12, wherein the performing of the ground estimation process is based on:
a pre-trained deep learning-based model applied to the pieces of data, or
a rule-based model that estimates ground points based on normal vectors associated with the pieces of point data.

14. The method of claim 11, wherein the performing of the MOS is based on:
aligning consecutive frames of the pieces of point data, or
detecting changes in occupied or unoccupied regions of a map generated from the pieces of point data.

15. A vehicle comprising:
a sensor configured to obtain point cloud data associated with at least one object in a surrounding environment of the vehicle;
a driving control circuit configured to control autonomous driving of the vehicle; and
a processor circuit configured to cause the vehicle to:
segment the point cloud data to distinguish points corresponding to the at least one object from points corresponding to a background,
generate, based on the points corresponding to the at least one object, a cluster corresponding to the at least one object,
generate a bounding box corresponding to the cluster,
apply contrastive learning to classify features extracted from the cluster,
determine, based on the classified features, that the cluster corresponds to a target object among the at least one object,
based on the determination and the bounding box, generate a pseudo ground truth bounding box corresponding to the target object,
output a signal indicating the pseudo ground truth bounding box, and
control, via the driving control circuit and the signal, autonomous driving of the vehicle.

16. The vehicle of claim 15, wherein the processor circuit is configured to cause the vehicle to remove points corresponding to a ground from the point cloud data prior to generating the cluster.

17. The vehicle of claim 15, wherein the processor circuit is configured to cause the vehicle to identify points corresponding to the at least one object by comparing consecutive frames of the point cloud data to detect motion of the at least one object.

18. The vehicle of claim 15, wherein the processor circuit is configured to cause the vehicle to track the pseudo ground truth bounding box across a plurality of frames of the point cloud data to maintain continuity of the target object.

19. The vehicle of claim 15, wherein the target object is in an unlabeled point cloud frame of the point cloud data, and wherein the processor circuit is configured to cause the vehicle to use the pseudo ground truth bounding box for training of an object recognition model associated with autonomous driving of the vehicle.

20. The vehicle of claim 15, wherein the processor circuit is configured to cause the vehicle to apply contrastive learning such that features extracted from clusters corresponding to a same class are adjusted to be closer together in a feature space and that features extracted from clusters corresponding to different classes are adjusted to be farther apart in the feature space.
